(19) United States
(12) Patent Application Publication
(10) Pub. No.: US 2026/0101895 A1
(43) Pub. Date: Apr. 16, 2026

(54) FUNGICIDAL AGENT AND COMPOSITION

(71) Applicant: Innospec Limited, Ellesmere Port (GB)

(72) Inventors: Thomas Alastair Hubbard, Goostrey (GB); Hannah Lucy HAZLEHURST, Ellesmere Post (GB)

(21) Appl. No.: 19/117,318

(22) PCT Filed: Oct. 2, 2023
(86) PCT No.: PCT/GB2023/052536

§ 371 Date: Mar. 31, 2025

(30) Foreign Application Priority Data
Oct. 7, 2022 (GB) 2214785.4

(51) Int. Cl. A01N 37/44; A01N 25/04; A01N 25/24; A01P 3/00

(52) U.S. Cl. CPC A01N 37/44; A01N 25/04; A01N 25/24; A01P 3/00

(57) ABSTRACT

A fungicidal composition including one or more copper amino carboxylic acid complexes, one or more dispersants, and one or more fillers. A fungicidal composition including one or more copper amino carboxylic acid complexes having a copper bioavailability of 20,000 to 100,000 ppm in which the composition is in a solid form.

### FIELD OF THE INVENTION

The present invention relates to fungicidal compositions comprising one or more copper amino carboxylic acid complexes and to a copper amino carboxylic acid complex having a specified copper bioavailability. The present invention also relates to uses of the fungicidal compositions and the copper amino carboxylic acid complex for controlling the growth of fungi on a surface, as well as to methods of controlling growth of fungi on a surface by applying the fungicidal compositions or the copper amino carboxylic acid complex.

### BACKGROUND

Fungi are known to grow on various surfaces and to thereby cause numerous problems. For example fungi are known to grow on plants, which causes disease and can inhibit production and/or reduce the quality of the plants. In some cases, fungi can infect and/or destroy the plants. When the plants are crops, for example intended to enter the human or animal food chain, then these issues have an economic and humanitarian effect. Additionally, infected crops can cause health hazards to humans and animals that ingest the crops.

Fungi that grow on other surfaces such as in commercial and industrial systems can also cause problems by interference with industrial processes causing lower process efficiency and reduction in product quality. The presence of fungi on such surfaces can also cause an unsafe working environment and potential health issues for personnel who are near to or come into contact with the surfaces.

It is known to use fungicidal (or anti-fungal) agents and compositions to reduce growth of fungi on surfaces. Copper based fungicidal agents are known and used for example for protecting crops against fungal growth. However, some known copper based fungicidal agents (and compositions containing them) do not provide the required efficacy in use, whereby they do not provide the optimal release of copper in use. For example, it is desirable, in use, for a copper based fungicidal agent to provide an initial anti-fungal effect upon release of copper and for a suitable amount of the agent to remain on the surface to which is it is applied so as to provide a step wise release of copper over time. When applied to a living species, such as a plant, it is also necessary for the agent to release copper in an amount that is not toxic to that living species (for example plant).

Additionally, the copper based fungicidal agent should not release the copper in amounts that can cause undesirable environmental issues. Copper fungicides are known to wash off surfaces such as leaves, leading to the risk of copper contamination of the surrounding area. For example, when used in an agricultural environment, copper may accumulate in soil and at certain levels may render the soil in a state in which plants cannot grow. This has led to incoming regulatory pressures to reduce the environmental burden of copper fungicides, for example to comply with rulings limiting the use of copper to 28 kg copper per hectare over 7 years or 4 kg of copper per hectare per year (reduced from 6 kg of copper per hectare per year that is permissible in 2022).

There is therefore a need to provide fungicidal agents and compositions that provide the desired release characteristics for efficient use in controlling the growth of fungi on a surface. There is especially a need for fungicidal agents and compositions that provide a lower environmental burden, for example because they are less easily washed off from the surface to which they are applied. This may additionally mean that less fungicide is required to be applied initially.

### SUMMARY

According to a first aspect of the present invention there is provided a fungicidal composition comprising one or more copper amino carboxylic acid complexes, one or more dispersants, and one or more fillers.

According to a second aspect of the present invention there is provided a fungicidal composition comprising one or more copper amino carboxylic acid complexes having a copper bioavailability of 20,000 to 100,000 ppm, wherein the composition is in a solid form.

According to a third aspect of the present invention there is provided a copper amino carboxylic acid complex having a copper bioavailability of 20,000 to 100,000 ppm.

According to a fourth aspect of the present invention there is provided a use of the fungicidal composition according to the first or second aspect of the invention or of the copper amino carboxylic acid complex according to the third aspect of the invention for controlling the growth of fungi on a surface.

According to a fifth aspect of the present invention there is provided a use of copper iminodiacetate for controlling the growth of fungi on a surface.

According to a sixth aspect of the present invention there is provided a method of controlling growth of fungi on a surface, the method comprising applying an effective amount of the fungicidal composition according to the first or second aspect of the invention or copper amino carboxylic acid complex according to the third aspect of the invention to the surface.

According to a seventh aspect of the present invention there is provided method of controlling growth of fungi on a surface, the method comprising applying an effective amount of copper iminodiacetate to the surface.

### DETAILED DESCRIPTION

Unless otherwise stated, the following terms used in the specification and claims have the meanings set out below.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate.

In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone, B alone, C alone, A and B in combination, A and C in combination, B and C in combination, or A, B, and C in combination.

According to a first aspect of the present invention there is provided a fungicidal composition comprising one or more copper amino carboxylic acid complexes, one or more dispersants, and one or more fillers.

According to a second aspect of the present invention there is provided a fungicidal composition comprising one or more copper amino carboxylic acid complexes having a copper bioavailability of 20,000 to 100,000 ppm, wherein the composition is in a solid form.

According to a third aspect of the present invention there is provided a copper amino carboxylic acid complex having a copper bioavailability of 20,000 to 100,000 ppm.

The copper amino carboxylic acid complex of the third aspect of the invention may have a copper bioavailability of 20,000 to 100,000 ppm after 2, or suitably 3, washings with deionised water at room temperature and pressure. For example, the copper amino carboxylic acid complex of the third aspect of the invention may have a copper bioavailability of 100,000 to 90,000 ppm after 2, or suitably 3, washings with deionised water at room temperature and pressure wherein the weight ratio of the copper complex to the deionised water is 1:50.

The copper amino carboxylic acid complex of the third aspect of the invention may have a copper bioavailability of 20,000 to 90,000 ppm after 2, or suitably 3, washings with deionised water at room temperature and pressure. For example, the copper amino carboxylic acid complex of the third aspect of the invention may have a copper bioavailability of 20,000 to 90,000 ppm after 2, or suitably 3, washings with deionised water at room temperature and pressure wherein the weight ratio of the copper complex to the deionised water is 1:50.

The copper amino carboxylic acid complex of the third aspect of the invention may have a copper bioavailability of 30,000 to 90,000 ppm after 2, or suitably 3, washings with deionised water at room temperature and pressure. For example, the copper amino carboxylic acid complex of the third aspect of the invention may have a copper bioavailability of 30,000 to 90,000 ppm after 2, or suitably 3, washings with deionised water at room temperature and pressure wherein the weight ratio of the copper complex to the deionised water is 1:50.

The copper amino carboxylic acid complex(es) acts/act as a fungicidal (or anti-fungal) agent. The copper amino carboxylic acid complexes may, in some cases, alternatively be referred to as salts.

By the term “fungicidal” we mean that the complex and/or composition acts to inhibit and/or control the growth of fungi. By “control the growth of fungi” we mean both to destroy fungi already present on a surface and/or to prevent growth of fungi on a surface. A fungicidal composition may alternatively be termed an “anti-fungal” composition.

By the term “copper bioavailability” we mean the amount of copper that is released upon contact with water, i.e. so as to provide free copper ions for consumption by fungi. Copper bioavailability values may be measured using any suitable method, including the method as set out in the Examples. The copper bioavailability may be determined by measuring the content of copper in a sample (for example using a colorimetric test that compares to copper nitrate solutions of known concentrations) and converting the copper content to an amount of bioavailable copper (in ppm) using the formula:

$$Bioavailable copper ( ppm ) = \frac{{Cu}^{2 +} content ( ppm ) \times mass of formulation}{volume of deionised water}$$

The fungicidal composition of the first aspect of the present invention may comprise any suitable one or more copper amino carboxylic acid complexes as described herein. Preferably in the first aspect of the invention, the one or more copper amino carboxylic acid complexes each have a copper bioavailability of 20,000 to 100,000 ppm.

The fungicidal composition of the second aspect of the invention comprises one or more copper amino carboxylic acid complexes having a copper bioavailability of 20,000 to 100,000 ppm.

The fungicidal composition of the first or second aspect of the invention comprises one or more copper amino carboxylic acid complexes.

The fungicidal composition of the first or second aspect of the invention may comprise two or more copper amino carboxylic acid complexes.

Any suitable one or more copper amino carboxylic acid complexes may be included in the compositions of the invention, provided that the/each complex has activity as a fungicidal (or anti-fungal) agent. Mixtures of two or more copper amino carboxylic acid complexes may be included in the compositions of the invention.

Preferably, the one or more copper amino carboxylic acid complexes included in the compositions of the first or second aspects of the invention each have a copper bioavailability of 20,000 to 100,000 ppm, for example 20,000 to 90,000 ppm, such as 30,000 to 90,000 ppm.

Preferably, the one or more copper amino carboxylic acid complexes included in the compositions of the first or second aspects of the invention each have a copper bioavailability of 20,000 to 100,000 ppm after 2, or suitably 3, washings with deionised water at room temperature and pressure. For example, the copper amino carboxylic acid complexes may each have a copper bioavailability of 20,000 to 100,000 ppm after 2, or suitably 3, washings with deionised water at room temperature and pressure wherein the weight ratio of the copper complex to the deionised water is 1:50.

Preferably, the one or more copper amino carboxylic acid complexes included in the compositions of the first or second aspects of the invention each have a copper bioavailability of 20,000 to 90,000 ppm after 2, or suitably 3, washings with deionised water at room temperature and pressure. For example, the one or more copper amino carboxylic acid complexes may each have a copper bioavailability of 20,000 to 90,000 ppm after 2, or suitably 3, washings with deionised water at room temperature and pressure wherein the weight ratio of the copper complex to the deionised water is 1:50.

Preferably, the one or more copper amino carboxylic acid complexes included in the compositions of the first or second aspects of the invention each have a copper bioavailability of 30,000 to 90,000 ppm after 2, or suitably 3, washings with deionised water at room temperature and pressure. For example, the one or more copper amino carboxylic acid complexes may each have a copper bioavailability of 30,000 to 90,000 ppm after 2, or suitably 3, washings with deionised water at room temperature and pressure wherein the weight ratio of the copper complex to the deionised water is 1:50.

Preferably, the one or more copper amino carboxylic acid complexes included in the compositions of the first or second aspects of the invention each provides a reduced copper wash-off from a surface to which it is applied compared to an alternative copper complex such as copper hydroxide. Preferably, the copper amino carboxylic acid complex of the third aspect of the invention provides a reduced copper wash-off from a surface to which it is applied compared to an alternative copper complex such as copper hydroxide. For example, the copper amino carboxylic acid complex(es) may each have a copper wash off of less than 80%, such as less than 70%, for example 50% or 40%. This is a reduced value compared with copper hydroxide.

Suitably, the reference to “copper wash-off” means after 2, or suitably 3, washings with deionised water at room temperature and pressure, such as after 2, or suitably 3, washings with deionised water at room temperature and pressure wherein the weight ratio of the copper complex to the deionised water is 1:50. A reduction in copper wash off is advantageous as it may reduce the environmental burden and/or require less copper complex (as fungicide) to be applied initially.

References herein to the copper bioavailability and to copper wash off of the copper amino carboxylic acid complex refer to the copper bioavailability and copper wash off of the complex per se and to the copper bioavailability and copper wash off of the complex when included in a composition according to the invention.

Preferably, the fungicidal composition of the first or second aspect of the invention may provide an effective fungicidal action on a surface by means of fewer applications to the surface compared to a fungicidal composition comprising an alternative copper complex such as copper hydroxide. For example, the fungicidal composition of the first or second aspect of the invention may provide an effective fungicidal action on a surface by means of fewer applications to the surface compared to a fungicidal composition comprising an alternative copper complex such as copper hydroxide in the same molar amount of copper as the fungicidal composition of the first or second aspect of the invention.

Preferably, the copper amino carboxylic acid complex according to the third aspect of the invention may provide an effective fungicidal action on a surface by means of fewer applications to the surface compared to an alternative copper complex such as copper hydroxide. For example, the copper amino carboxylic acid complex according to the third aspect of the invention may provide an effective fungicidal action on a surface by means of fewer applications to the surface compared to an alternative copper complex such as copper hydroxide based on the same molar amount of copper.

Suitable copper amino carboxylic acid complexes (i.e. to be included in the compositions of the first or second aspects of the invention or according to the third aspect of the invention) may be formed by reaction of a copper compound, such as a copper salt, and an amino carboxylic acid compound. By an “amino carboxylic acid compound” we mean a compound comprising both at least one amino group and at least one carboxylic acid group. By an “amino polycarboxylic acid compound” we mean a compound comprising at least one amino group and at least two carboxylic acid groups. The term “amino polycarboxylic acid compound” includes within its scope an amino dicarboxylic acid compound, which has two carboxylic acid groups.

The copper compound and the amino carboxylic acid compound may be reacted in any suitable molar ratio so as to provide the desired copper amino carboxylic acid complex. Suitable molar ratios of copper compound to amino carboxylic acid compound may be 1:1 to 1:3, for example 1:2.

The copper compound and the amino carboxylic acid compound may be reacted in any suitable solvent and at any suitable temperature, such as from 20 to 80° C. Suitably, the solvent is one from which the copper amino carboxylic acid complex can be precipitated, such as water or a water/ethanol mixture (50:50 water:ethanol by volume).

Any suitable copper compound may be used to prepare the copper amino carboxylic acid complex. The copper compound may be a copper (I) compound and/or a copper (II) compound. For example, the copper compound may be a copper salt such as copper hydroxide, copper oxychloride, copper acetate, copper sulfate, copper nitrate, copper phosphate, copper oxide, copper carbonate or a copper halide (for example copper chloride). Preferably, the copper compound is copper hydroxide.

The copper amino carboxylic acid complex may be formed by reaction of copper hydroxide and an amino carboxylic acid compound.

Any suitable amino carboxylic acid compound may be used to prepare the copper amino carboxylic acid complex.

A mixture of two or more amino carboxylic acid compounds may be used to prepare a mixture of two or more copper amino carboxylic acid complexes, which two or more complexes may be used in the compositions, methods and uses of the invention.

The amino carboxylic acid compound may be selected from one or more of glycine, lysine, tyrosine, threonine, proline, isoleucine, arginine, asparagine, phenylalanine, sarcosine, aminododecanoic acid, aminooctanoic acid, iminodiacetic acid, aspartic acid, ethylenediamine-N,N′-bis(2-hydroxyphenylacetic acid), methionine, serine, threonine, alanine, cysteine, glutamic acid, glutamine, histidine, leucine, tryptophan, valine, 4-aminosalicylic acid, 11-aminoundecenoic acid, 12-aminododecanoic acid, 6-aminohexanoic acid, 3-amino-4-methylbenzoic acid, 4-aminophenylacetic acid, 3-aminobutanoic acid, norvaline, norleucine, 2-aminocaprylic acid, γ-aminobutyric acid, ethylenediaminetetraacetic acid (EDTA), ethylenediamine-N,N′-disuccinic acid (EDDS), nitrile triaceticacid (NTA), pentetic acid (DTPA), (ethylene glycol-bis(β-aminoethyl ether)-N,N,N,N-tetraacetic acid) (EGTA), 1,2-bis(o-aminophenoxy) ethane-N,N,N′,N′-tetraacetic acid (BAPTA), tetraxetan (DOTA), methylglycine diacetic acid (MGDA), glutamic acid-N,N-diacetic acid (GLDA), and iminodisuccinic acid (IDS).

The amino carboxylic acid compound may be selected from one or more of glycine, lysine, tyrosine, threonine, proline, isoleucine, arginine, asparagine, phenylalanine, sarcosine, aminododecanoic acid, aminooctanoic acid, iminodiacetic acid, aspartic acid and ethylenediamine-N,N′-bis(2-hydroxyphenylacetic acid). Suitably, the amino carboxylic acid compound may be glycine or iminodiacetic acid.

For example, the amino carboxylic acid compound may comprise an amino monocarboxylic acid or an amino polycarboxylic acid (for example an amino dicarboxylic acid). In other words, the copper amino carboxylic acid complex may be formed from an amino monocarboxylic acid or an amino polycarboxylic acid (for example an amino dicarboxylic acid).

Suitably, the amino carboxylic acid compound may be a naturally occurring compound. For example, the amino carboxylic acid compound may comprise a naturally occurring amino acid, such as glycine, lysine, tyrosine, threonine, proline, isoleucine, arginine, asparagine, phenylalanine, methionine, serine, threonine, alanine, aspartic acid, cysteine, glutamic acid, glutamine, histidine, leucine, tryptophan and valine.

Suitably, the amino carboxylic acid compound may comprise an amino monocarboxylic acid. In other words, the copper amino carboxylic acid complex may be formed from an amino monocarboxylic acid.

Suitably, the amino carboxylic acid compound may comprise an amino polycarboxylic acid, such as an amino dicarboxylic acid. In other words, the copper amino carboxylic acid complex may be formed from an amino polycarboxylic acid, such as an amino dicarboxylic acid.

Suitably, the amino carboxylic acid compound may comprise an amino dicarboxylic acid. In other words, the copper amino carboxylic acid complex may be formed from an amino dicarboxylic acid.

The amino monocarboxylic acid may be selected from one or more of glycine, lysine, tyrosine, threonine, proline, isoleucine, arginine, asparagine, phenylalanine, sarcosine, aminododecanoic acid, aminooctanoic acid, methionine, serine, threonine, alanine, cysteine, glutamine, histidine, leucine, tryptophan, valine, 4-aminosalicylic acid, 11-aminoundecenoic acid, 12-aminododecanoic acid, 6-aminohexanoic acid, 3-amino-4-methylbenzoic acid, 4-aminophenylacetic acid, 3-aminobutanoic acid, norvaline, norleucine, 2-aminocaprylic acid and γ-aminobutyric acid. Preferably, the amino monocarboxylic acid is selected from one or more of glycine, lysine, and tyrosine, more preferably the amino monocarboxylic acid is glycine.

The amino polycarboxylic acid may be selected from one or more of ethylenediaminetetraacetic acid (EDTA), ethylenediamine-N,N′-disuccinic acid (EDDS), nitrile triaceticacid (NTA), pentetic acid (DTPA), (ethylene glycol-bis(β-aminoethyl ether)-N,N,N′,N′-tetraacetic acid) (EGTA), 1,2-bis(o-aminophenoxy) ethane-N,N,N,N-tetraacetic acid) (BAPTA), tetraxetan (DOTA), iminodiacetic acid, glutamic acid, aspartic acid, ethylenediamine-N,N′-bis(2-hydroxyphenylacetic acid), methylglycine diacetic acid (MGDA), glutamic acid-N,N-diacetic acid (GLDA), and iminodisuccinic acid (IDS). Preferably, the amino polycarboxylic acid is iminodiacetic acid.

The amino dicarboxylic acid may be selected from one or more of iminodiacetic acid, aspartic acid and ethylenediamine-N,N′-bis(2-hydroxyphenylacetic acid). Preferably, the amino dicarboxylic acid is iminodiacetic acid.

The copper amino carboxylic acid complex (i.e. to be included in the compositions of the first or second aspects of the invention or according to the third aspect of the invention) may be in any suitable form.

The copper amino carboxylic acid complex may be in a hydrated form, such as a mono, di or higher hydrate. For example, copper glycinate may be in the form of a mono hydrate, di or higher hydrate (suitable a mono or dihydrate).

“Copper glycinate” may alternatively be referred to as copper bisglycinate or copper (glycine) 2.

The copper amino carboxylic acid complex (i.e. to be included in the compositions of the first or second aspects of the invention or according to the third aspect of the invention) may be selected from one or more of copper threoninate, copper prolinate, copper isoleucinate, copper argininate, copper lysinate, copper tyrosinate, copper asparaginate, copper phenylalaninate, copper sarcosinate, copper glycinate, copper iminodiacetate, copper 12-aminododecanoate, copper 2-aminooctanoate, copper aspartate, copper EDDHA, copper methioninate, copper serinate, copper threoninate, copper alaninate, copper cysteinate, copper glutamate, copper glutamine, copper histidinate, copper leucinate, copper tryptophanate, copper valinate, copper 4-aminosalicylate, copper 11-aminoundecenoate, copper 12-aminododecanoate, copper 6-aminohexadecanoate, copper 3-amino-4-methylbenzoate, copper 4-aminophenylacetate, copper 3-aminobutanoate, copper norvalinate, copper norleucinate, copper 2-aminocaprylate, copper γ-aminobutyrate, copper EDTA, copper EDDS, copper NTA, copper DTPA, copper EGTA, copper BAPTA, copper DOTA, copper MGDA, copper GLDA and copper IDS. The copper amino carboxylic acid complex may be selected from one or more of copper threoninate, copper prolinate, copper isoleucinate, copper argininate, copper lysinate, copper tyrosinate, copper asparaginate, copper phenylalaninate, copper sarcosinate, copper glycinate, copper iminodiacetate, copper 12-aminododecanoate and copper 2-aminooctanoate. Preferably, the copper amino carboxylic acid complex may be selected from one or more of copper lysinate, copper glycinate and copper iminodiacetate, more preferably copper glycinate and copper iminodiacetate.

Preferably, the copper amino carboxylic acid complex may be selected from one or more of copper lysinate, copper glycinate and copper iminodiacetate, wherein the copper lysinate, copper glycinate and copper iminodiacetate are formed from copper hydroxide.

Preferably, the copper amino carboxylic acid complex may be selected from copper glycinate and copper iminodiacetate, wherein the copper glycinate and copper iminodiacetate are formed from copper hydroxide.

Preferably, the copper amino carboxylic acid complex is copper glycinate, wherein the copper glycinate is formed from copper hydroxide.

Preferably, the copper amino carboxylic acid complex is copper iminodiacetate, wherein the copper iminodiacetate is formed from copper hydroxide.

The copper amino carboxylic acid complex having a copper bioavailability of 20,000 to 100,000 ppm may be selected from one or more of copper glycinate and copper iminodiacetate.

The copper amino carboxylic acid complex, for example the complex having a copper bioavailability of 20,000 to 100,000 ppm, may be copper glycinate.

The copper amino carboxylic acid complex, for example the complex having a copper bioavailability of 20,000 to 100,000 ppm, may be copper iminodiacetate.

The compositions of the invention may comprise the one or more copper amino carboxylic acid complexes in any suitable amount. For example, the compositions of the invention may comprise up to 99%, such as up to 90%, for example up to 80% by weight of the one or more copper amino carboxylic acid complexes (i.e. of the total copper amino carboxylic acid complexes).

The compositions of the invention may comprise at least 1%, such as at least 10%, for example at least 20% by weight of the one or more copper amino carboxylic acid complexes (i.e. of the total copper amino carboxylic acid complexes).

The compositions of the invention may comprise from 1 to 99%, such as from 10 to 95%, by weight of the one or more copper amino carboxylic acid complexes (i.e. of the total copper amino carboxylic acid complexes).

The compositions of the invention may comprise from 100 to 600 g of total one or more copper amino carboxylic acid complexes per kg of total composition.

The fungicidal composition of the first aspect of the invention may take any suitable form and is preferably in a solid form. The fungicidal composition of the second aspect of the invention is in a solid form. For example, the fungicidal compositions of the invention may be in the form of granules, flakes, powders, tablets or pellets (preferably granules). Preferably, the fungicidal compositions of the invention are water-dispersible or water-soluble.

The fungicidal compositions of the invention may be in the form of a concentrate which forms a solution, suspension, emulsifiable concentrate, liquid concentrate, capsule concentrate or dispersion (preferably solution or suspension) upon mixing with a solvent, preferably water. For example, the fungicidal compositions of the invention may be in a solid form (such as granules, flakes, powders, tablets or pellets, preferably granules) which provide a concentrate for mixing with a solvent (preferably water) to provide a solution, suspension, emulsifiable concentrate, liquid concentrate, capsule concentrate or dispersion (preferably solution or suspension) which is suitable for applying to a surface such as by spraying.

The fungicidal composition of the first aspect of the invention comprises one or more dispersants and one or more fillers and may comprise any suitable additional components. The fungicidal composition of the second aspect of the invention may comprise any suitable additional components, such as for example one or more dispersants and/or one or more fillers.

Suitable dispersants include lignin sulfonates, naphthalene sulfonates, polycarboxylates, naphthalene sulfonate condensates, acyl N-methyl taurates (especially methyl oleyl taurate), phenol sulfonic acid condensates, polyvinyl alcohol and (where relevant) alkali metal salts and ammonium salts, and combinations thereof.

Suitable fillers include diatomaceous earth, calcium carbonate, calcium bicarbonate, calcium bentonite clay and sodium bentonite clay, silica (for example fumed silica and/or precipitated silica), kaolin, attapulgite, perlite, and combinations thereof.

Suitable further additional components may include anti-foaming agents, emulsifying agents, wetting agents, chelating agents, stabilisers, non-ionic surfactants, anionic surfactants, additional fungicidal agents, herbicidal agents, insecticidal agents, nematicidal agents, and bactericidal agents (including antibiotic bactericidal agents), disintegrating agents, binding agents, anti-caking agents, and combinations thereof.

The skilled person would know to select the appropriate amount and combination of further additional components to include in the fungicidal compositions, for example to maintain a solid composition (when required).

The fungicidal compositions of the invention may, for example, further comprise one or more of an anti-foaming agent, a stabiliser and a wetting agent.

Suitable anti-foaming agents may include siloxane antifoaming agents (for example polydimethylsiloxane), and combinations thereof.

Suitable stabilisers many include polyoxyethylene-alkylethers, polyoxyethylene-alkylarylethers, polyoxypropylene-alkylethers, polyoxypropylene-alkylarylethers, polyoxyethylene-polyoxypropylene block polymers, polyethyleneglycols, polypropyleneglycols: alkylbenzene sulfonates, cellulose, microcrystalline cellulose, microfibrillated cellulose, and silicates (for example magnesium aluminium silicate), and combinations thereof.

Suitable wetting agents may include di-alkyl sulfosuccinates (for example di-octyl sulfosuccinate), alkyl polyglycosides (for example coco glucoside), alkylbenzene sulfonates, naphthalene sulfonates, alkyl sulfates, alpha-olefin sulfonates, acyl N-methyl taurates (for example sodium methyl cocoyl taurate), and phosphate esters, and combinations thereof.

Suitable emulsifying agents may include alkyl benzenesulfonates, and combinations thereof.

Suitable chelating agents may include NTA, EDTA, EDDS, IDS, GLDA, HEDP, DTPA, DTPMP, and salts thereof (for example disodium EDTA and tetrasodium EDTA), and combinations thereof.

Suitable anionic surfactants may include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, alkylbenzene sulfonates especially toluene sulfonate, xylene sulfonate and cumene sulfonate, alkyl diphenyloxide sulfonates, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, acyl alkyl isethionates, N-acyl taurates, N-acyl-N-alkyltaurates, and alkyl carboxylates, and

Suitable non-ionic surfactants may include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids for example castor oil ethoxylates, alkanolamine condensates, alkanolamides, tertiary acetylenic glycols, polyoxyethylenated mercaptans, carboxylic acid esters, polyoxyethylenated polyoxyproylene glycols, sorbitan fatty esters, ethylene oxide-propylene oxide block copolymers, polyamine, polyethyleneimines, polyvinylpyrolidones, sorbitan fatty acid alcohol ethoxylates and sorbitan fatty acid ester ethoxylates, and combinations thereof.

Suitable additional fungicidal agents may include acylalanines (such as benalaxyl, metalaxyl, ofurace, oxadixyl), amine derivatives (such as aldimorph, dodine, dodemorph, fenpropimorph, fenpropidin, guazatine, iminoctadine, spiroxamin, tridemorph), anilinopyrimidines (such as pyrimethanil, mepanipyrim or cyrodinyl), antibiotics (such as cycloheximide, griseofulvin, kasugamycin [note this is included in one of the prior art documents], natamycin, polyoxin, oxytetracyclin or streptomycin), azoles (such as bitertanol, bromoconazole, cyproconazole, difenoconazole, dinitroconazole, enilconazole, epoxiconazole, fenbuconazole, fluquinconazole, flusilazole, hexaconazole, imazalil, metconazole, myclobutanil, penconazole, propiconazole, prochloraz, prothioconazole, tebuconazole, triadimefon, triadimenol, triflumizol, triticonazole), dicarboximides (such as iprodione, myclozoline, procymidone, vinclozoline), dithiocarbamates (such as ferbam, nabam, maneb, mancozeb, metam, metiram, propineb, polycarbamate, thiram, ziram, zineb), heterocylic compounds (such as anilazine, benomyl, boscalid, carbendazim, carboxin, oxycarboxin, cyazofamid, dazomet, dithianon, famoxadone, fenamidone, fenarimol, fuberidazole), nitrophenyl derivatives (such as binapacryl, dinocap, dinobuton, nitrophthal-isopropyl), phenylpyrroles (such as fenpiclonil or fludioxonil), sulfur, and fungicidal copper salts such as copper hydroxide, copper oxychloride and copper sulfate, and combinations thereof.

Further suitable additional fungicidal agents may include acibenzolar-S-methyl, benthiavalicarb, carpropamid, chlorothalonil, cyflufenamid, cymoxanil, dazomet, diclomezine, diclocymet, diethofencarb, edifenphos, ethaboxam, fenhexamid, fentin acetate, fenoxanil, ferimzone, fluazinam, fosetyl, fosetyl aluminum, iprovalicarb, hexachlorobenzene, metrafenon, pencycuron, propamocarb, phthalide, toloclofos-methyl, quintozene, zoxamid, benzalkonium chloride or hydroxyquinoline sulfate, strobilurins (such as azoxystrobin, dimoxystrobin, fluoxastrobin, kresoxim-methyl, metominostrobin, orysastrobin, picoxystrobin, pyraclostrobin or trifloxystrobin), sulfenic acid derivatives (such as captafol, captan, dichlofluanid, folpet, tolylfluanid), cinnamamides and analogues (such as dimethomorph, flumetover or flumorph), and

Suitable herbicides may include 2,4-D, aminopyralid, chlorsulforn, clopyralid, dicamba, diuron, Flucetosulfuron, flufenpyr-ethyl, glyphosate, hexazinone, imazapic, imazapyr, metamifop, methsulfuron methyl, orthosulfamuron, picloram, pinoxaden, pyrasulfotole, pyroxsulam, saflufenacil, sulfometuron methyl tembotrione, thiencarbazone-methyl, topramezone and triclopyr, and combinations thereof.

Suitable insecticides may include chlorantraniliprole, organochlorine, organophosphates, organosulfur, carbamates, formamidines, flubendiamide, dinitrophenols, organotins, pyrethroids, nicotinoids, spinosyns, pyrazoles, oyridazinones, quinazolines, botanicals, pyrethrum, nicotine, rotenone, limonene, neem, antibiotics, fumigants, metofluthrin, prifluquinazon, spirotetramat, cyantraniliproe, cyflumetofen, and benzoylureas, and combinations thereof.

Suitable nemanticidal agents may include calcium EDDS, 1,3 dichloropropene (1,3-D), chloropicrin, metam sodium, metam potassium, dimethyl disulfide, allyl isothiocyanate, oxamyl, fluensulfone, fluopyram, ethoprop, terbufos and fluazaindolizine, and combinations thereof.

Suitable bactericidal agents include C12-16(alkyl) dimethylbenzyl ammonium chlorides, and combinations thereof.

Suitable disintegrating agents include cross-linked sodium carboxymethyl cellulose, and styrene-(meth)acrylic acid copolymers, and combinations thereof.

Suitable binding agents include linseed oil, natural clays and synthetic clays, and combinations thereof.

Suitable anti-caking agents include potassium ferrocyanide, sodium aluminosilicate, tricalcium phosphate, silica and microcrystalline cellulose, and combinations thereof.

The dispersant (when present) may be included in the compositions of the invention in any suitable amount. For example, the compositions of the invention may comprise up to 20% by weight of one or more dispersants. The compositions of the invention may comprise at least 1% by weight of one or more dispersants. The compositions of the invention may comprise from 1 to 20%, such as from 2 to 20%, by weight of one or more dispersants (i.e. of the total dispersants).

The filler (when present) may be included in the compositions of the invention in any suitable amount. For example, the compositions of the invention may comprise up to 60%, such as up to 50%, by weight of one or more fillers. The compositions of the invention may comprise at least 3%, such as at least 5%, by weight of one or more fillers. The compositions of the invention may comprise from 3 to 60%, such as from 5 to 50%, by weight of a one or more fillers (i.e. of the total fillers).

The wetting agent (when present) may be included in the compositions of the invention in any suitable amount. For example, the compositions of the invention may comprise up to 5% by weight of one or more wetting agents. The compositions of the invention may comprise at least 0.5%, such as at least 1%, by weight of one or more wetting agents. The compositions of the invention may comprise from 0.5 to 5%, such as from 1 to 5%, by weight of one or more wetting agents (i.e. of the total wetting agents).

The anti-foaming agent (when present) may be included in the compositions of the invention in any suitable amount. For example, the compositions of the invention may comprise up to 0.5% by weight of one or more anti-foaming agents. The compositions of the invention may comprise at least 0.01% by weight of one or more anti-foaming agents. The compositions of the invention may comprise from 0.01 to 0.5% by weight of one or more anti-foaming agents (i.e. of the total anti-foaming agents).

Further additional components and combinations thereof may be included in the compositions of the invention in any suitable amount, as would be readily determined by persons skilled in the art.

The fungicidal compositions and copper amino carboxylic acid complex as described herein may be used to control the growth of fungi on a surface.

References to fungi include any fungi, including Candida sp., Aspergillus sp., Fusarium sp., Cryptococcus sp., Staphylococcus sp., Escherichia coli, Phytophthora sp., Pythium sp., Colletotrichum sp., Helminthosporium sp., Alternaria sp., Puccinia sp., Sclerotinia sp., Cercospora sp., Rhizoctonia sp., Microsporum sp., Tricophyton sp., Astomycete sp., Tinea pedis, and other filamentous fungi, and fungi commonly known as mildew.

For example, fungi, the growth of which may be controlled according to the invention, include Aspergillus niger, Aspergillus fumigatus, Candida albicans, Candida glabrata, Candida parapsilosis, Candida krusei, Candida tropicalis, Coccidioides immitis, Cryptococcus neoformans, Histoplasma capsulatum, Trichoderma atroviride, Piptoporus betulinus, Staphylococcus aureus, Plasmopara viticola, Pseudoperonospora cubensis, Pyricularia oryzae, Septoria nodorum, Leptosphaeria nodorum, Ustilago maydis, Erysiphe graminis, Sphaerotheca fuliginea, Uncinula necator, Septoria tritici, and Podosphaera leucotricha, Gleophyllum trabeur, Phialophora mutabilis, Poria palcenta, Trametes versicolor, Erysiphales and Peronospora tabacina.

According to a third aspect of the present invention there is provided a use of the fungicidal composition according to the first or second aspect of the invention or of the copper amino carboxylic acid complex according to the third aspect of the invention for controlling the growth of fungi on a surface.

According to a fourth aspect of the present invention there is provided a use of copper iminodiacetate for controlling the growth of fungi on a surface.

Copper iminodiacetate may be formed by reaction of a copper compound, such as a copper salt (for example copper hydroxide), and iminodiacetic acid.

According to a fifth aspect of the present invention there is provided a method of controlling growth of fungi on a surface, the method comprising applying an effective amount of the fungicidal composition according to the first or second aspect of the invention or of the copper amino carboxylic acid complex according to the third aspect of the invention to the surface.

According to a sixth aspect of the present invention there is provided a method of controlling growth of fungi on a surface, the method comprising applying an effective amount of copper iminodiacetate to the surface.

The fungicidal compositions, the copper amino carboxylic acid complex and the copper iminodiacetate as described herein may be used to control the growth of fungi on any suitable surface. Suitable surfaces include solid and/or hard surfaces, especially those exposed to air and moisture. Examples of suitable surfaces include surfaces of domestic equipment, industrial equipment, medical equipment, food preparation and/or processing equipment, agricultural equipment, plants (especially their leaves), and human and animal bodies.

By “plants” we include trees, shrubs, herbs, grasses, vines, ferns, and mosses, typically growing in a permanent site. The plants may be those that produce fruit, grain and/or vegetables, such that the uses described herein may apply to plant crops for agricultural purposes. Examples of suitable crops include grape vines, citrus plants, potato plants and tomato plants.

The surface may be a surface of a plant, for example a leaf of a plant.

The surface may be a surface of domestic equipment, industrial equipment, medical equipment, food preparation and/or processing equipment, or agricultural equipment.

The surface may be a surface of domestic equipment, industrial equipment, medical equipment, or food preparation and/or processing equipment.

The methods of the invention comprise the step of applying an effective amount of the fungicidal composition or of the copper amino carboxylic acid complex according to the invention to the surface. The composition or complex may be applied to the surface by any suitable means. Suitably, the composition or complex may be applied by spraying.

For example, the fungicidal composition or copper amino carboxylic acid complex of the invention may be applied as an aqueous solution or dispersion by spraying on to the surface.

Solid compositions as described herein may be made into a liquid formulation prior to being applied (for example by spraying) to the surface to be treated. The liquid formulation may be in the form of a suspension, solution, emulsifiable concentrate, liquid concentrate, capsule concentrate, or dispersion. Suitably, the liquid formulation is an aqueous formulation.

The liquid formulation may include further additives in addition to those listed above. These further additives may include stabilising agents, co-solvents, and/or anti-freeze agents.

Suitable stabilising agents may include alcohols for example ethanol, methanol and glycerol.

Suitable co-solvents may include alkanols, benzyl acetate, dialkyl carbonates (for example dibutyl carbonate), and lactic acid esters (for example ethyl hexyl lactate).

Suitable anti-freeze agents may include ethylene glycol, propylene glycol, urea, glycerol, and anti-freeze proteins.

Features of the compositions and of the copper amino carboxylic acid complexes in relation to the uses and methods described herein are as set out herein in relation to the compositions and complexes.

The invention will now be further described with reference to the following non-limiting examples.

### EXAMPLES

The copper bioavailability of a copper amino carboxylic acid complex was determined according to the following method:

### Colorimetric Determination of Copper Content:

The colorimetric absorbance at 635 nm using a Hach Lange DR3900 Spectrophotometer of copper nitrate solutions of known concentrations gives a linear relationship where:

$${Cu}^{2 +} content ( ppm ) = \frac{( Absorbance - 6 \times 1 {0}^{- 4} )}{8 \times 1 {0}^{- 5}}$$

Absorbance is relative to a standard solution of 9.9 ml deionised water, 0.1 ml 68 to 70% nitric acid

The copper content is converted to bioavailable copper using the formula:

$$Bioavailable copper ( ppm ) = \frac{{Cu}^{2 +} content ( ppm ) \times mass of formulation}{volume of deionised water}$$

To determine the copper content of each of the copper amino carboxylic acid complexes, 9.9 ml of filtered copper containing solution and 0.1 mL of 68 to 70% nitric acid was added to a spectrometer vial to completely react all of the copper complex to copper nitrate.

The absorbance at 635 nm (pre-zeroed with solution of 9.9 mL deionised water and 0.1 mL nitric acid) was recorded.

The initial and repeated solubility of a copper amino carboxylic acid complex was determined according to the following methods:

### Initial Solubility:

A solution of each copper amino carboxylic acid complex was prepared by dissolving 2 g of the copper complex in 100 ml deionised water and stirring at room temperature for 20 minutes. A sample of this solution was then withdrawn and filtered through a 0.45 μm syringe.

The filtered copper liquid was diluted with 1% nitric acid to yield a solution containing an approximate maximum of 1 mg/L Cu2+. The total copper content was then determined using a Perkin Elmer NexION 350D and converted to bioavailable copper using the formula above.

### Repeated Solubility:

1 g of each copper amino carboxylic acid complex was added to 50 ml deionised water in a 50 ml centrifuge tube and stirred. The resulting mixture was centrifuged at 4000 rpm for 30 minutes, a sample of this was withdrawn and filtered through a 0.45 μm syringe. The copper content was determined using the above colorimetric method.

The remaining liquid in the centrifuge tube was poured away leaving only some undissolved material. 50 ml of fresh deionised water was added to the centrifuge tube containing undissolved material. The stirring and centrifugation process was repeated until no undissolved material remained.

These measurements indicate the bioavailability of the copper over repeated wettings in use.

### Example 1—Synthesis of Copper Glycinate

Glycine (35 g) was added to 250 ml DI water with stirring at room temperature. Once all glycine had dissolved, copper hydroxide (25 g) was added portionwise and stirred for 1 hour. The resultant mixture was filtered through a Buchner funnel under vacuum. The collected solid material was dried in an oven at 43° C. for 96 hours. The dried solid was ground into a powder using a Waring blender.

### Example 2—Synthesis of Copper Iminodiacetate

Iminodiacetic acid (45 g) was added to 250 ml DI water with stirring and heated to 65° C. Once all iminodiacetic acid had dissolved, copper hydroxide (25 g) was added portionwise and stirring was maintained at 65° C. for 1 hour. The mixture was then cooled to room temperature and filtered through a Buchner funnel under vacuum. The collected solid material was dried in an oven at 43° C. for 72 hours.

### Example 3—Synthesis of Other Copper Amino Carboxylic Acid Complexes

Copper acetate·H₂O was dissolved in a 50/50 by volume deionised water/ethanol mixture at 60° C. Amino acid (in a 1:2 molar ratio copper:amino acid) in deionised water was added with stirring. The resultant solution was cooled to 5° C. If a precipitate was formed, it was filtered out using a Buchner funnel under vacuum. Otherwise, the solution was concentrated in vacuo until a thick oil had formed. The solid or oil was dried under vacuum at 75° C. for 24 to 48 hours to yield the copper complex.

The copper complexes prepared are listed in Table 1 below, along with their copper bioavailability values as determined from initial solubility measurements.

TABLE 1

| Copper complex | Bioavailable Cu by ICP-MS (ppm) |
|---|---|
| Copper threoninate | 233050 |
| Copper prolinate | 227150 |
| Copper isoleucinate | 13050 |
| Copper argininate | 152250 |
| Copper lysinate | 106950 |
| Copper tyrosinate | 3200 |
| Copper L-asparaginate | 7125 |
| Copper phenylalaninate | 5250 |
| Copper sarcosinate | 278000 |
| Copper glycinate | 86500 |
| Copper iminodiacetate | 33000 |
| Copper 12-aminododecanoate | 9200 |
| Copper 2-aminooctanoate | 150 |

The copper bioavailability values as determined from repeated solubility measurements for the copper complexes copper glycinate, copper iminodiacetate, copper lysinate and copper tyrosinate are provided in Table 2 below.

TABLE 2

| | Bioavailable copper | | | | |
|---|---|---|---|---|---|
| | Step 1 | Step 2 | Step 3 | Step 4 | Step 5 |
| Copper complex | (ppm) | (ppm) | (ppm) | (ppm) | (ppm) |
| Copper glycinate | 85875 | 85250 | 70875 | 0 | 0 |
| Copper iminodiacetate | 27750 | 27750 | 27750 | 27750 | 27125 |
| Copper lysinate | 79000 | 24000 | 8375 | 4000 | 0 |
| Copper tyrosinate | 4937 | 6187 | 2125 | 6812 | 9937 |

Table 2 shows that copper glycinate and copper iminodiacetate have good bioavailability for 3 or more wettings/steps.

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A fungicidal composition comprising one or more copper amino carboxylic acid complexes, one or more dispersants, and one or more fillers.

2. The fungicidal composition according to claim 1, wherein the one or more copper amino carboxylic acid complexes each have a copper bioavailability of 20,000 to 100,000 ppm.

3. The fungicidal composition according to claim 1, further comprising one or more of an anti-foaming agent, a stabiliser, a wetting agent, an anti-foaming agent, an emulsifying agent, a chelating agent, a stabiliser, a non-ionic surfactant, an anionic surfactant, an additional fungicidal agent, a herbicidal agent, an insecticidal agent, a nematicidal agent, a bactericidal agent, a disintegrating agent, a binding agent, an anti-caking agent and combinations thereof.

4. A fungicidal composition comprising one or more copper amino carboxylic acid complexes each having a copper bioavailability of 20,000 to 100,000 ppm, wherein the composition is in a solid form.

5. The fungicidal composition according to claim 1, wherein the one or more copper amino carboxylic acid complexes each have a copper bioavailability of 20,000 to 90,000 ppm after 2, or suitably 3, washings with deionised water at room temperature and pressure.

6. The fungicidal composition according to claim 1, wherein the one or more copper amino carboxylic acid complexes each provides a reduced copper wash-off from a surface to which it is applied compared to an alternative copper complex.

7. The fungicidal composition according to claim 1, wherein the composition provides an effective fungicidal action on a surface by means of fewer applications to the surface compared to a fungicidal composition comprising an alternative copper complex such as copper hydroxide.

8. The fungicidal composition according to claim 1, wherein the fungicidal composition is granules, flakes, powders, tablets or pellets.

9. The fungicidal composition according to claim 1, wherein the fungicidal composition is a concentrate which forms a solution, suspension, emulsifiable concentrate, liquid concentrate, capsule concentrate or dispersion upon mixing with a solvent.

10. A copper amino carboxylic acid complex having a copper bioavailability of 20,000 to 100,000 ppm.

11. The copper amino carboxylic acid complex according to claim 10, having a copper bioavailability of 20,000 to 90.000 ppm after 2, or suitably 3, washings with deionised water at room temperature and pressure.

12. The copper amino carboxylic acid complex according to claim 10, wherein the complex provides a reduced copper wash-off from a surface to which it is applied compared to an alternative copper complex such as copper hydroxide.

13. The copper amino carboxylic acid complex according to claim 10, wherein the complex provides an effective fungicidal action on a surface by means of fewer applications to the surface compared to an alternative copper complex such as copper hydroxide.

14. The fungicidal composition according to claim 1 or the copper amino carboxylic acid complex according to claim 10, wherein the copper amino carboxylic acid complex is formed from an amino monocarboxylic acid or an amino polycarboxylic acid.

15. The fungicidal composition or the copper amino carboxylic acid complex according to claim 14, wherein the copper amino carboxylic acid complex is formed from an amino monocarboxylic acid selected from one or more of glycine, lysine and tyrosine.

16. The fungicidal composition or the copper amino carboxylic acid complex according to claim 14, wherein the copper amino carboxylic acid complex is formed from an amino dicarboxylic acid selected from one or more of iminodiacetic acid, aspartic acid and ethylenediamine-N,N′-bis(2-hydroxyphenylacetic acid).

17. Use of the fungicidal composition or the copper amino carboxylic acid complex according to claim 1 for controlling the growth of fungi on a surface.

18. The use of claim 17, wherein copper amino carboxylic acid complex copper iminodiacetate at an effective concentration for controlling the growth of fungi on a surface.

19. The use according to claim 17, wherein the surface is a surface of a plant.

20. The use according to claim 17, wherein the surface is a surface of domestic equipment, industrial equipment, medical equipment, food preparation and/or processing equipment, or agricultural equipment.

21. A method of controlling growth of fungi on a surface, the method comprising applying an effective amount of the fungicidal composition or the copper amino carboxylic acid complex according to claim 1 to the surface.

22. A method of controlling growth of fungi on a surface, the method comprising applying an effective amount of copper iminodiacetate to the surface.

23. The method according to claim 21 wherein the fungicidal composition or copper amino carboxylic acid complex is applied as an aqueous solution or dispersion by spraying on to the surface.

24. The method according to claim 21, wherein the surface is a surface of a plant.

25. The method according to claim 21, wherein the surface is a surface of domestic equipment, industrial equipment, medical equipment, food preparation and/or processing equipment, or agricultural equipment.

26. The use according to claim 17 or the method according to claim 21, wherein the fungi are one or more of Candida sp., Aspergillus sp., Fusarium sp., Cryptococcus sp., Staphylococcus sp., Escherichia coli, Phytophthora sp., Pythium sp., Colletotrichum sp., Helminthosporium sp., Alternaria sp., Puccinia sp., Sclerotinia sp., Cercospora sp., Rhizoctonia sp., Microsporum sp., Tricophyton sp., Astomycete sp., Tinea pedis and other filamentous fungi, and fungi commonly known as mildew.
